(19) United States
(12) Patent Application Publication
(10) Pub. No.: US 2024/0383342 A1
(43) Pub. Date: Nov. 21, 2024

(54) HIGH VOLTAGE BATTERY MOUNTING STRUCTURE FOR ELECTRIC VEHICLE

(71) Applicants: Hyundai Motor Company, Seoul (KR); Kia Corporation, Seoul (KR)

(72) Inventors: Kang Hyuck Kwon, Suwon (KR); Se Young Han, Yongin (KR)

(21) Appl. No.: 18/388,073

(22) Filed: Nov. 8, 2023

(30) Foreign Application Priority Data
May 18, 2023 (KR) 10-2023-0064101

(51) Int. Cl. B60L 50/64; H01M 50/244; H01M 50/262

(52) U.S. Cl. CPC B60L 50/64; H01M 50/244; H01M 50/262; H01M 2220/20

(57) ABSTRACT

A high voltage battery mounting structure for an electric vehicle includes a battery module mounted on a center floor panel, front battery mounting members configured to extend from front side seal parts that support the center floor panel towards an inside of a vehicle, and coupled to front side members, and rear battery mounting members configured to connect rear side seal parts that support the center floor panel to a rear cross member, where the battery module is coupled to the front battery mounting members and the rear battery mounting members. The battery module may be coupled to the front and rear battery mounting members in a state in which the battery module is disposed such that a front part and a rear part of the battery module overlap the front battery mounting members and the rear battery mounting members, respectively.

### CROSS-REFERENCE TO RELATED APPLICATION

This application claims under 35 U.S.C. § 119(a) the benefit of Korean Patent Application No. 10-2023-0064101 filed on May 18, 2023, the entire contents of which are incorporated herein by reference.

### BACKGROUND

### (a) Technical Field

The present disclosure relates to a high voltage battery mounting structure for an electric vehicle, more particularly, to the high voltage battery mounting structure that allows battery main members to be directly coupled to vehicle body main members so as to improve structural robustness.

### (b) Description of the Related Art

An electric vehicle refers to a vehicle that uses electricity as a power source, i.e., a vehicle which obtains driving energy from an electric motor instead of a gas-based engine, and thus avoids burning fossil fuels, where the electric motor may be operated using electricity accumulated in a battery.

Such an electric vehicle travels by using accumulated electricity without using gas during driving, does not emit carbon dioxide or nitrogen dioxide, and is thus eco-friendly, and may be more economical than a gas-based vehicle due to low operating costs when the electric vehicle is driven using only the electric motor.

In the electric vehicle, the battery conventionally is detachably mounted on a central mounting member of a vehicle body, and a front mounting member and a rear mounting member are respectively provided in front of and at the rear of the mounted battery, and thereby, the battery is installed on the vehicle body.

However, in such a conventional battery mounting structure, the front mounting member and the rear mounting member of the battery are not connected to main components of the vehicle body, and even if these mounting members are connected to the main components through separate brackets, connection structures may not be optimized, which may negatively affect torsional stiffness of the vehicle.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a structure for preventing movement and separation of a battery module mounted on a center floor panel, and is configured to couple extensions extending from front and rear parts of battery modules directly to front battery mounting members and rear battery mounting members, respectively, so as to improve torsional stiffness of a vehicle by increasing structural robustness in order to achieve improved driving performance and durability performance of the vehicle.

In one aspect, the present disclosure provides a high voltage battery mounting structure for electric vehicles, including a battery module mounted on a center floor panel, front battery mounting members configured to extend from front side seal parts configured to support the center floor panel towards an inside of a vehicle, and coupled to front side members, and rear battery mounting members configured to connect rear side seal parts configured to support the center floor panel to a rear cross member, wherein the battery module is coupled to the front battery mounting members and the rear battery mounting members in a state in which the battery module is disposed such that a front part and a rear part thereof overlap the front battery mounting members and the rear battery mounting members.

In a preferred embodiment, the front battery mounting members may connect the front side seal parts to a dash panel provided on the center floor panel.

In another preferred embodiment, the battery module may have extensions provided to extend towards a pair of the front battery mounting members and a pair of the rear battery mounting members.

In still another preferred embodiment, the extensions configured to extend towards the pair of front battery mounting members may be divided into a plurality of extensions corresponding to a length and shape of the front battery mounting members, and the extensions configured to extend towards the pair of rear battery mounting members may be divided into a plurality of extensions corresponding to a length and shape of the rear battery mounting members.

In yet another preferred embodiment, the front battery mounting members may extend in a vertical direction so as to overlap the extensions, and may thus have a closed cross-section.

In still yet another preferred embodiment, the front battery mounting members may have a plurality of fastening holes formed at positions corresponding to a plurality of through holes formed through the extensions.

In a further preferred embodiment, the high voltage battery mounting structure may further include fastening members inserted into the through holes and the fastening holes in a state in which the through holes and the fastening holes coincide with each other, and fastened to nut members provided in the front battery mounting members and the extensions so as to fasten the battery module.

In another further preferred embodiment, a part of each of the front battery mounting members may be connected to an interior-side dash cross member of the vehicle.

In still another further preferred embodiment, the rear battery mounting members may extend in a vertical direction so as to overlap the extensions, and thus have a closed cross-section.

In yet another further preferred embodiment, each of the rear battery mounting members may include a first panel coupled to the extensions so as to overlap the extensions, and a second panel configured to extend so as to have a closed cross-section in a state in which the first panel is coupled to the extensions so as to overlap the extensions, and coupled to the rear cross member.

In still yet another further preferred embodiment, the rear battery mounting members may have a plurality of bulkheads provided therein.

In a still further preferred embodiment, the rear battery mounting members may have a plurality of fastening holes formed at positions corresponding to a plurality of through holes formed through the extensions.

In a yet still further preferred embodiment, the high voltage battery mounting structure may further include fastening members inserted into the through holes and the fastening holes in a state in which the through holes and the fastening holes coincide with each other, and fastened to nut members provided in the rear battery mounting members and the extensions so as to fasten the battery module.

A vehicle may include the high voltage battery mounting structure.

An electric vehicle may include the high voltage battery mounting structure.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view illustrating battery mounting members of a high voltage battery mounting structure for electric vehicles according to one embodiment of the present disclosure;

FIG. 2 is a perspective view illustrating a mounting state of a battery module on the high voltage battery mounting structure according to one embodiment of the present disclosure;

FIGS. 3A to 3C (RELATED ART) are views illustrating a conventional battery mounting structure;

FIG. 4 is an enlarged view of area A of FIG. 2 illustrating the high voltage battery mounting structure according to one embodiment of the present disclosure;

FIG. 5 is a cross-sectional view taken along line A-A of FIG. 4 illustrating the high voltage battery mounting structure according to one embodiment of the present disclosure;

FIG. 6 is an enlarged view of area B of FIG. 2 illustrating the high voltage battery mounting structure according to one embodiment of the present disclosure;

FIG. 7 is a cross-sectional view taken along line B-B of FIG. 6 illustrating the high voltage battery mounting structure according to one embodiment of the present disclosure; and

FIG. 8 is a view illustrating bulkheads of the high voltage battery mounting structure according to one embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, reference will be made in detail to various embodiments of the present disclosure, examples of which are illustrated in the accompanying drawings and described below.

Advantages and features of the present disclosure and methods for achieving the same will become apparent from the descriptions of the embodiments herein below with reference to the accompanying drawings.

However, the present disclosure is not limited to the embodiments disclosed herein and may be implemented in various different forms, and these embodiments are provided to make the description of the present disclosure thorough and to fully convey the scope of the present disclosure to those skilled in the art. It is to be noted that the scope of the present disclosure is defined only by the claims.

In the following description of the present disclosure, a detailed description of known functions and configurations incorporated herein will be omitted when it may make the subject matter of the present disclosure rather unclear.

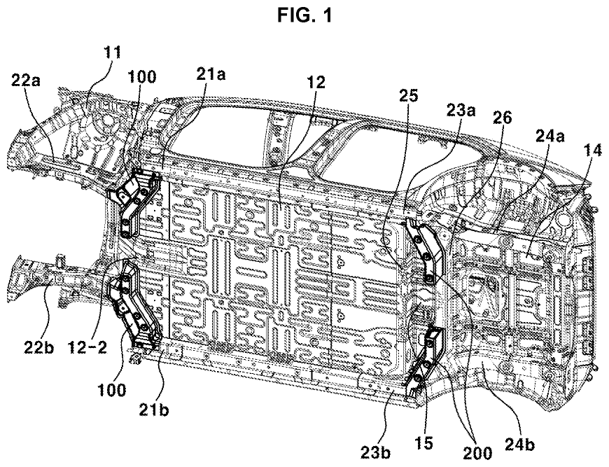

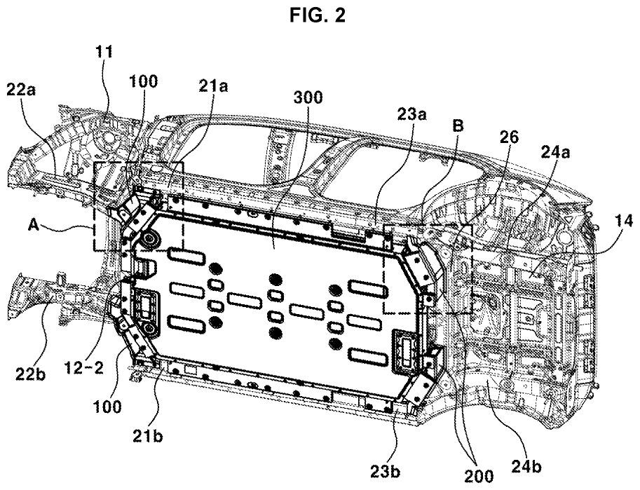

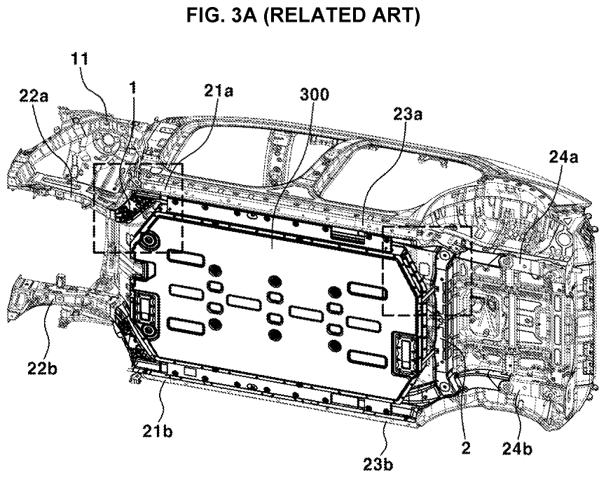

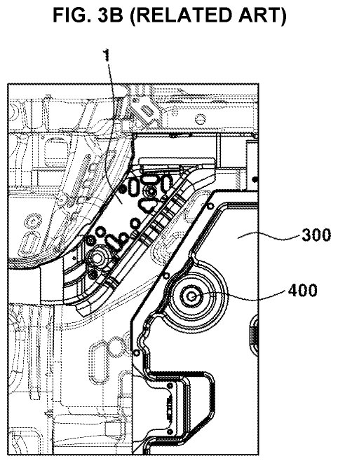

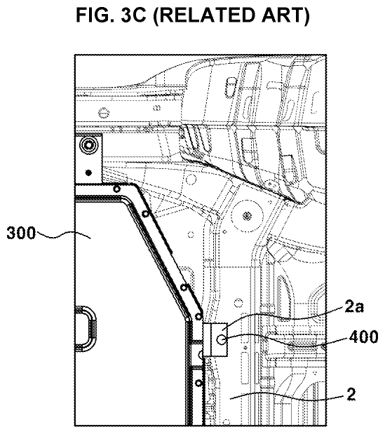

FIG. 1 is a perspective view illustrating battery mounting members of a high voltage battery mounting structure for electric vehicles according to one embodiment of the present disclosure, FIG. 2 is a perspective view illustrating a mounting state of a battery module on the high voltage battery mounting structure according to one embodiment of the present disclosure, and FIGS. 3A to 3C (RELATED ART) are views illustrating a conventional battery mounting structure.

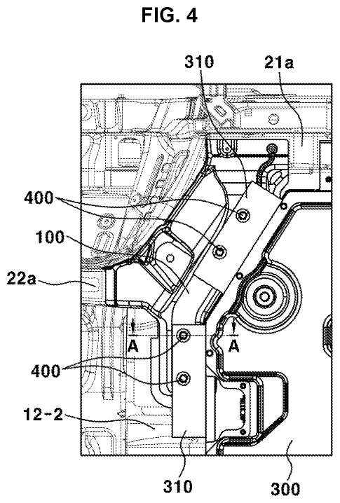

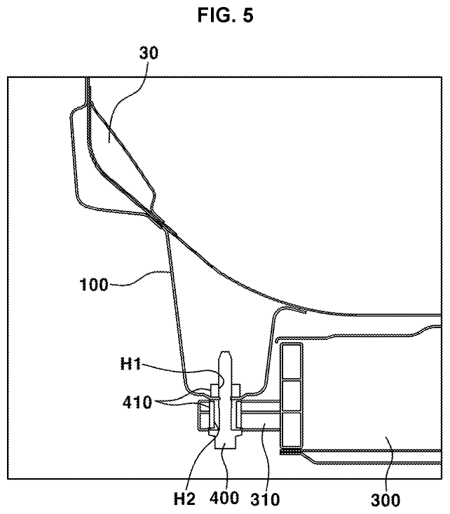

Further, FIG. 4 is an enlarged view of area A of FIG. 2 illustrating the high voltage battery mounting structure according to one embodiment of the present disclosure, and FIG. 5 is a cross-sectional view taken along line A-A of FIG. 4 illustrating the high voltage battery mounting structure according to one embodiment of the present disclosure.

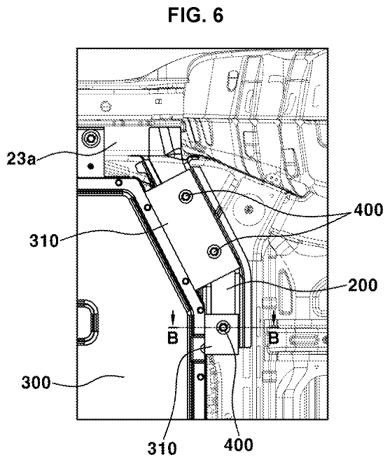

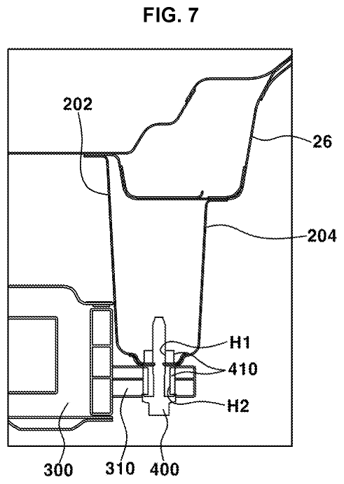

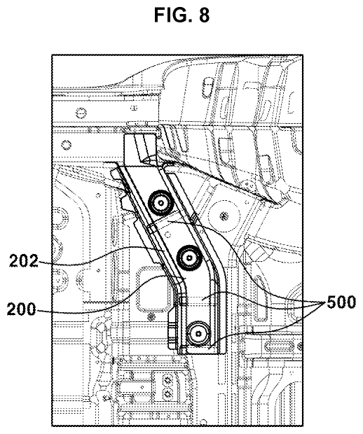

In addition, FIG. 6 is an enlarged view of area B of FIG. 2 illustrating the high voltage battery mounting structure according to one embodiment of the present disclosure, FIG. 7 is a cross-sectional view taken along line B-B of FIG. 6 illustrating the high voltage battery mounting structure according to one embodiment of the present disclosure, and FIG. 8 is a view illustrating bulkheads of the high voltage battery mounting structure according to one embodiment of the present disclosure.

Referring to FIGS. 1 to 3A, a vehicle panel assembly may include a dash panel 11, a center floor panel 12, a rear floor panel 14, and a vertical panel 15.

The dash panel 11 is configured to divide the interior and the exterior of a vehicle, and the exterior of the vehicle includes an engine compartment disposed in front of front seats of the vehicle.

The center floor panel 12 is coupled to the lower end of the dash panel 11 to be fixed, extends from the lower end of the dash panel 11 towards the rear part of the vehicle, and forms the bottom of the front part of the interior of the vehicle, and for example, the front seats may be disposed on the bottom of the front part of the interior of the vehicle.

The front end of the center floor panel 12 may be coupled to the lower end of the dash panel 11 through welding.

All components forming the underbody of the vehicle may be coupled to each other through welding, or well-known coupling technology, which is generally used to couple components, may be applied, beside welding, and the components of the underbody may have welding flanges or the like so as to be coupled to each other through welding.

Further, the center floor panel 12 has a dash panel 12-2 at the central part of the center floor panel 12 in the lateral direction of the vehicle.

Here, the dash panel 12-2 is configured in a shape protruding upwards from the central part of the center floor panel 12, and the dash panel 12-2 protrudes upwards while being bending into a C shape.

The rear floor panel 14 is coupled to the rear end of the center floor panel 12 to be fixed, extends from the rear end of the center floor panel 12 towards the rear part of the vehicle, and forms the bottom of the rear part of the interior of the vehicle, and for example, rear seats may be disposed on the bottom of the rear part of the interior of the vehicle.

The front end of the rear floor panel 14 may be coupled to the rear end of the center floor panel 12 through welding or the like.

The rear floor panel 14 may be connected to the center floor panel 12 through the vertical panel 15, and the vertical panel 15 may connect the rear end of the center floor panel 12 to the front end of the rear floor panel 14 by fixedly coupling the upper end of the vertical panel 15 to the front end of the rear floor panel 14 and fixedly coupling the lower end of the vertical panel 15 to the rear end of the center floor panel 12.

Further, a lower member assembly coupled to the above-described panel assembly includes main longitudinal members including a pair of front side seal parts 21a and 21b and a pair of rear side seal parts 23a and 23b, a pair of front side members 22a and 22b, and a pair of rear side members 24a and 24b, and reinforcement members including a front cross member 25 and a rear cross member 26.

The main longitudinal members are main members configured to absorb collision energy while forming the basic framework of the lower member assembly, and the pair of front side seal parts 21a and 21b and the pair of rear side seal parts 23a and 23b may be configured in a beam type having a predetermined length in the longitudinal direction of the vehicle, and may be respectively fixed to the left and right ends of the center floor panel 12 when the lower member assembly is coupled to the panel assembly.

In the above-described general structure, as shown in FIG. 3A (RELATED ART), the pair of front side seal parts 21a and 21b and the pair of rear side seal parts 23a and 23b are connected to the pair of front side members 22a and 22b and the pair of rear side members 24a and 24b through front battery mounting members 1 and a rear battery mounting member 2, thereby being capable of securing vehicle stiffness. Further, through the structure of a battery module 300 mounted on the center floor panel 12 so as to prevent movement and separation of the battery module 300, the mounted battery module 300 itself may be used as a rigid member together with the structures of the above described front and rear battery mounting members 1 and 2.

However, because the front battery mounting member 1 is spaced apart from the battery module 300 and the fastened positions of fastening members 400 to the battery module 300 are spaced apart from the edge of the battery module 300, as shown in FIG. 3B (RELATED ART), which is an enlarged view of a front box area shown in a dotted line in FIG. 3A, such a structure may make it difficult for high voltage batteries to serve as a member configured to reinforce stiffness.

Further, because the rear battery mounting member 2 is also spaced apart from the battery module 300 and is connected to the battery module 300 through separate mounting brackets 2a, as shown in FIG. 3C (RELATED ART), which is an enlarged view of a rear box area shown in a dotted line in FIG. 3A, such a mounting structure of the battery module 300 may not provide a rigid connection structure, compared to a directly coupling structure, and thus, such a structure may make it difficult for the high voltage batteries to serve as the member configured to reinforce stiffness.

For this purpose, the high voltage battery mounting structure according to this embodiment may include, as shown in FIGS. 1 and 2, front battery mounting members 100 and rear battery mounting members 200 configured to provide a mounting structure for the battery module 300.

The front battery mounting members 100 are formed in a designated shape, connect the dash panel 12-2 provided on the center floor panel 12 and the front side seal parts 21a and 21b to each other, and couple the dash panel 12-2 and the front side seal parts 21a and 21b to the pair of front side members 22a and 22b, as shown in FIG. 4.

In the same manner, the rear battery mounting members 200 are also formed in a designated shape, and connect the rear side seal parts 23a and 23b to the rear cross member 26 for connecting the rear side seal parts 23a and 23b to the pair of rear side members 24a and 24b, as shown in FIG. 6.

Here, both sides of the battery module 300 are coupled to the center floor panel 12 so that the battery module 300 is mounted thereon, and, in this case, the battery module 300 is directly coupled to the front battery mounting members 100 and the rear battery mounting members 200 in the state in which the battery module 300 is disposed such that the front part and the rear part thereof overlap the front battery mounting members 100 and the rear battery mounting members 200, thereby being capable of improving torsional stiffness of the vehicle due to improvement in structural robustness, compared to the above-described conventional structure in which the battery module 300 is separated from the front and rear battery mounting members 1 and 2 (with reference to FIGS. 3A to 3C).

In order to directly couple the battery module 300 to the front battery mounting members 100 and the rear battery mounting members 200, as described above, the battery module 300 has extensions 310 extending towards the pair of front battery mounting members 100 and the pair of rear battery mounting members 200.

More particularly, the extensions 310 extending towards the pair of front battery mounting members 100 may be divided into a pair of extensions 310 corresponding to the length and shape of the pair of front battery mounting members 100, and the extensions 310 extending towards the pair of rear battery mounting members 200 may be divided into a pair of extensions 310 corresponding to the length and shape of the pair of rear battery mounting members 200.

Further, the extensions 310 are not provided as separate additional elements, and may be manufactured integrally with the battery module 300 through extrusion molding to form the shapes of the front and rear parts of the battery module 300.

The front battery mounting member 100 extends to a length in the vertical direction so as to overlap the extensions 310 and thus forms a closed cross-section, and has a plurality of fastening holes H1 formed at positions corresponding to a plurality of through holes H2 formed through the extensions 310, as shown in FIG. 5.

The front battery mounting member 100 may be coupled to the extensions 310 by inserting the fastening members 400 into the through holes H2 and the fastening holes H1 in the state in which the through holes H2 and the fastening holes H1 coincide with each other, and more particularly, the front battery mounting member 100 may be directly coupled to the battery module 300 by coupling the fastening members 400 to nut members 410 respectively provided in the front battery mounting member 100 and the extensions 300.

More particularly, the front battery mounting members 100 and the extensions 310 may be coupled at a plurality of points, for example, 8 points in the lateral direction, in front of the battery module 300 by bolting (with reference to FIG. 2), and the front battery mounting members 100 may be connected to an interior-side dash cross member 30 (with reference to FIG. 5), thereby being capable of improving structural robustness of not only the battery module 300 but also the front battery mounting members 100 coupled to the battery module 300.

The rear mounting member 200 may be provided in a form in which a first panel 202 configured to overlap the extensions 310 and a second panel 204 extending to have a length in the vertical direction so as to form a closed cross-section are coupled to each other, and have a plurality of fastening holes H1 formed at positions corresponding to a plurality of through holes H2 formed through the extensions 310, as shown in FIG. 7.

The rear battery mounting member 200 may be coupled to the extensions 310 by inserting the fastening members 400 into the through holes H2 and the fastening holes H1 in the state in which the through holes H2 and the fastening holes H1 coincide with each other, and more particularly, the front battery mounting members 200 may be directly coupled to the battery module 300 by coupling the fastening members 400 to nut members 410 respectively provided in the rear battery mounting member 200 and the extensions 300.

More particularly, the rear battery mounting members 200 and the extensions 310 may be coupled at a plurality of points, for example, 6 points in the lateral direction, in the rear of the battery module 300 by bolting (with reference to FIG. 2), and a plurality of bulkheads 500 located at positions overlapping the extensions 310 and configured to surround the inner surface of the rear battery mounting member 200 together with the first panel 202 is provided in the rear battery mounding members 200, as shown in FIG. 8, thereby being capable of improving structural robustness of not only the battery module 300 but also the rear battery mounting members 200 coupled to the battery module 300.

That is, in this embodiment, in coupling the battery module 300 to the center floor panel 12, the extensions 310 may be directly coupled to the front battery mounting members 100 and the rear battery mounting members 200, which extend in the vertical direction, and thus, movement and separation of the battery module 300 may be prevented through such coupling structures at the front and rear parts of the battery module 300, and the battery module 300 mounted on the center floor panel 12 may serve as a rigid member, thereby being capable of extending usage of the battery module 300 and improving torsional stiffness of the vehicle, thus being capable of improving driving performance and durability performance of the vehicle, compared to the conventional battery mounting structure.

The present disclosure provides a structure which may prevent movement and separation of a battery module mounted on a center floor panel, and may couple extensions extending from the front and rear parts of the battery modules directly to front battery mounting members and rear battery mounting members, thereby being capable of improving torsional stiffness of a vehicle due to improvement in structural robustness, and thus achieving improvement in driving performance and durability performance of the vehicle.

As is apparent from the above description, the present disclosure provides a structure which may prevent movement and separation of a battery module mounted on a center floor panel, and may couple extensions extending from the front and rear parts of the battery modules directly to front battery mounting members and rear battery mounting members, thereby being capable of improving torsional stiffness of a vehicle due to improvement in structural robustness, and thus achieving improvement in driving performance and durability performance of the vehicle.

The disclosure has been described in detail with reference to preferred embodiments thereof. However, it should be apparent to those skilled in the art that various substitutions, changes and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

What is claimed is:

1. A high voltage battery mounting structure for an electric vehicle, comprising:
a battery module mounted on a center floor panel;
front battery mounting members configured to extend from front side seal parts configured to support the center floor panel towards an inside of the electric vehicle, and coupled to front side members; and
rear battery mounting members configured to connect rear side seal parts configured to support the center floor panel to a rear cross member,
wherein the battery module is coupled to the front battery mounting members and the rear battery mounting members.

2. The high voltage battery mounting structure of claim 1, wherein the battery module is disposed such that a front part and a rear part of the battery module overlap the front battery mounting members and the rear battery mounting members, respectively.

3. The high voltage battery mounting structure of claim 1, wherein the front battery mounting members connect the front side seal parts to a dash panel provided on the center floor panel.

4. The high voltage battery mounting structure of claim 1, wherein the battery module includes extensions provided to extend towards a pair of the front battery mounting members and a pair of the rear battery mounting members.

5. The high voltage battery mounting structure of claim 4, wherein the extensions configured to extend towards the pair of front battery mounting members are divided into a plurality of extensions corresponding to a length and shape of the front battery mounting members.

6. The high voltage battery mounting structure of claim 4, wherein the extensions configured to extend towards the pair of rear battery mounting members are divided into a plurality of extensions corresponding to a length and shape of the rear battery mounting members

7. The high voltage battery mounting structure of claim 4, wherein the front battery mounting members extend in a vertical direction so as to overlap the extensions.

8. The high voltage battery mounting structure of claim 7, where the front battery mounting members have a closed cross-section.

9. The high voltage battery mounting structure of claim 4, wherein the front battery mounting members have a plurality of fastening holes formed at positions corresponding to a plurality of through holes formed through the extensions.

10. The high voltage battery mounting structure of claim 9, further comprising fastening members inserted into the through holes and the fastening holes in a state in which the through holes and the fastening holes coincide with each other, the fastening members being fastened to nut members provided in the front battery mounting members and the extensions so as to fasten the battery module.

11. The high voltage battery mounting structure of claim 4, wherein the rear battery mounting members extend in a vertical direction so as to overlap the extensions, and thus have a closed cross-section.

12. The high voltage battery mounting structure of claim 11, where the front battery mounting members have a closed cross-section.

13. The high voltage battery mounting structure of claim 11, wherein each of the rear battery mounting members comprises:
a first panel coupled to the extensions so as to overlap the extensions; and
a second panel configured to extend so as to have a closed cross-section in a state in which the first panel is coupled to the extensions so as to overlap the extensions, and coupled to the rear cross member.

14. The high voltage battery mounting structure of claim 4, wherein the rear battery mounting members have a plurality of fastening holes formed at positions corresponding to a plurality of through holes formed through the extensions.

15. The high voltage battery mounting structure of claim 14, further comprising fastening members inserted into the through holes and the fastening holes in a state in which the through holes and the fastening holes coincide with each other, and fastened to nut members provided in the rear battery mounting members and the extensions so as to fasten the battery module.

16. The high voltage battery mounting structure of claim 1, wherein a part of each of the front battery mounting members is connected to an interior-side dash cross member of the vehicle.

17. The high voltage battery mounting structure of claim 1, wherein the rear battery mounting members have a plurality of bulkheads provided therein.

18. A vehicle comprising the high voltage battery mounting structure of claim 1.

19. An electric vehicle comprising the high voltage battery mounting structure of claim 1.
